(19) United States
(12) Patent Application Publication
(10) Pub. No.: US 2024/0251100 A1
(43) Pub. Date: Jul. 25, 2024

(54) SYSTEMS AND METHODS FOR MULTI-STREAM VIDEO ENCODING

(71) Applicant: Meta Platforms Technologies, LLC, Menlo Park, CA (US)

(72) Inventor: Colleen Kelly Henry, Oakland, CA (US)

(21) Appl. No.: 18/147,449

(22) Filed: Dec. 28, 2022

(51) Int. Cl. H04N 19/59; H04N 7/01; H04N 21/234; H04N 21/2662

(52) U.S. Cl. CPC H04N 19/59; H04N 7/013; H04N 21/23418; H04N 21/2662

(57) ABSTRACT

A computer-implemented method for multi-stream video encoding may include (i) identifying a video stream that includes a static element that changes less frequently between video frames relative to at least one dynamic element within the video stream that changes more frequently between video frames, (ii) extracting data representing the static element from the video stream, (iii) encoding the data representing the static element as a higher-quality video stream having a higher quality relative to a separate, lower-quality video stream of encoded data representing the dynamic element within the video stream, and (iv) transmitting, to a receiving device, the higher-quality video stream and lower-quality video stream in a manner that enables the higher-and lower-quality video streams to be recombined on the receiving device. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for multi-stream video encoding.

FIG. 2 is a flow diagram of an exemplary method for multi-stream video encoding.

FIG. 3 is an illustration of an exemplary video frame to be encoded.

FIG. 4 is an illustration of exemplary pixels in a video stream changing between frames.

FIG. 5 is an illustration of an exemplary video stream split into two streams for separate encoding.

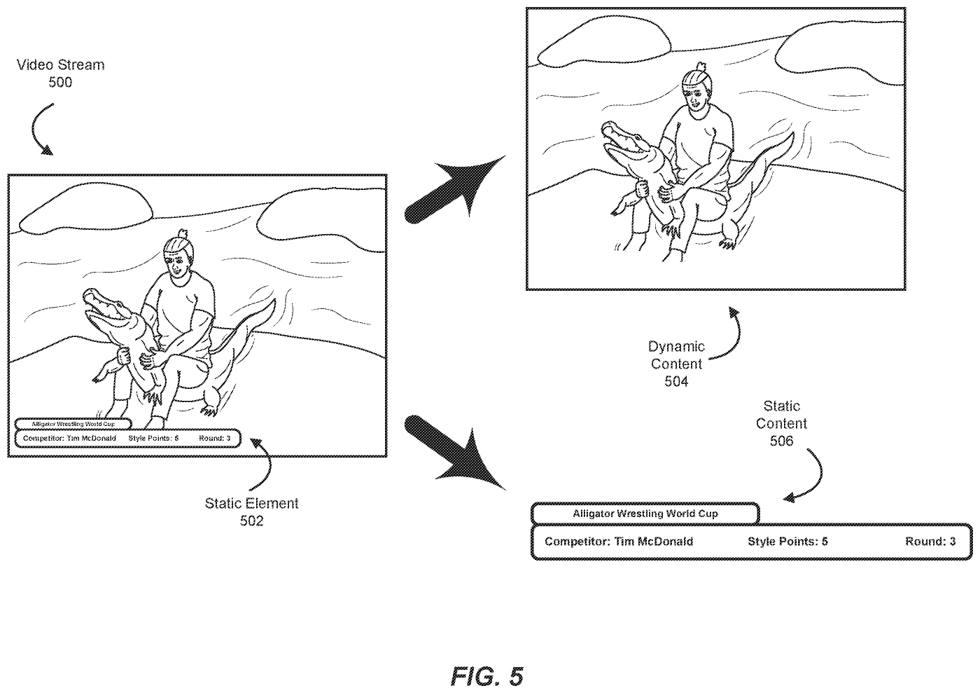

FIG. 6 is a block diagram of an exemplary system for video encoding via encoding two separate video streams.

FIG. 7 is a flow diagram of an exemplary method for encoding video based on the type of content within the video.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

The human eye can easily detect blurriness in static objects, such as the score overlay on a sporting event, but has more trouble detecting blurriness in moving objects such as the logo on a soccer that's in motion. The present disclosure is generally directed to systems and methods for streaming video efficiently by separating out static information (such as score overlays, name overlays, etc.) and motion (e.g., moving humans) into separate video streams. In some embodiments, the smaller stream of the static information may be encoded and transmitted at higher resolution while the larger stream of motion may be encoded and transmitted at lower resolution without a human viewer experiencing a decline in observed quality when viewing the recombined streams. Splitting and recombining streams in this way may lead to an improved viewing experience (e.g., because perceived video quality is higher) while conserving bandwidth by transmitting the bulk of the data at a lower resolution.

In some embodiments, the systems described herein may improve the functioning of a computing device by reducing the computing resources required to transmit a video stream. Additionally, the systems described herein may improve the field of streaming video by reducing the network bandwidth needed to transmit video streams at a higher subjective quality level.

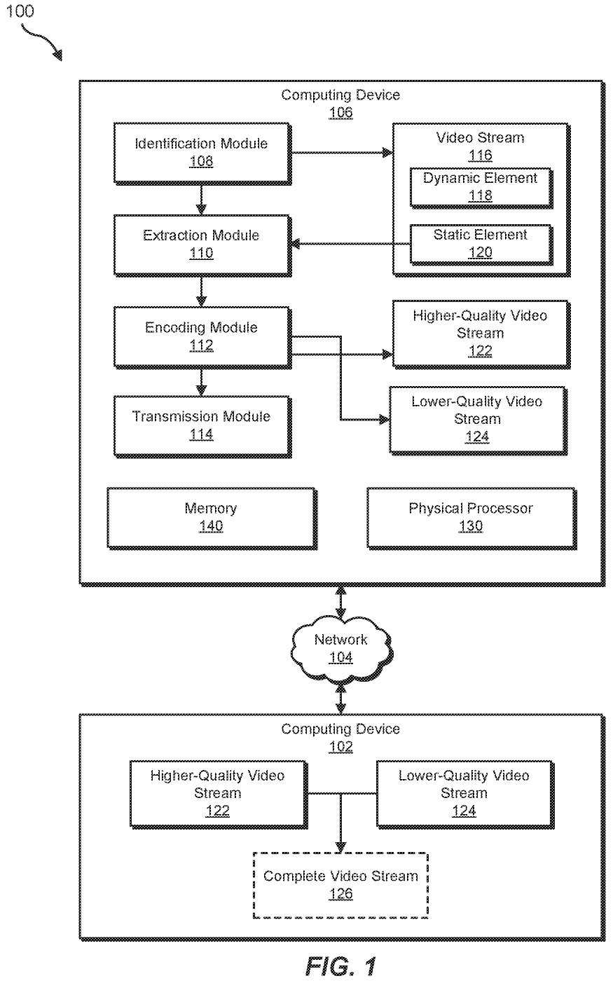

In some embodiments, the systems described herein may be configured on a computing device that transmits video to one or more additional devices. FIG. 1 is a block diagram of an exemplary system 100 for multi-stream video encoding. In one embodiment, and as will be described in greater detail below, a computing device 106 may be configured with an identification module 108 that may identify a video stream 116 that includes a static element 120 that changes less frequently between video frames relative to at least one dynamic element 118 within video stream 116 that changes more frequently between video frames. Next, an extraction module 110 may extract data representing static element 120 from video stream 116. After the data is extracted, an encoding module 112 may encode the data representing static element 120 as a higher-quality video stream 122 having a higher quality relative to a separate, lower-quality video stream 124 of encoded data representing dynamic element 118. Once the data is encoded, a transmission module 114 may transmit, to a computing device 102 (e.g., via a network or series of networks such as network 104), higher-quality video stream 122 and lower-quality video stream 124 in a manner that enables the higher-and lower-quality video streams to be recombined on computing device 102 (e.g., into a complete video stream 126). Various other methods, systems, and computer-readable media are also disclosed.

Computing device 106 generally represents any type or form of computing device capable of processing video. For example, computing device 106 may represent a specialized computing device such as a media processing server. Alternatively, computing device 106 may represent a general-purpose computing device such as an application server or a personal computing device (e.g., laptop, desktop, etc.).

Computing device 102 generally represents any type or form of computing device capable of reading computer-executable instructions. For example, computing device 102 may represent an endpoint computing device. In another example, computing device 102 may represent an intermediate computing device that receives and processes video for use by endpoint computing devices (e.g., a home media server that serves video to a smart television). Additional examples of computing device 102 may include, without limitation, a laptop, a desktop, a wearable device, a smart device, an artificial reality device, a personal digital assistant (PDA), etc.

Video stream 116 generally represents any type or form of digital video data. In some embodiments, video stream 116 may include raw video footage that has not yet been processed or encoded. Alternatively, video stream 116 may include encoded video files. In some examples, video stream 116 may be a live stream that is processed as it is recorded. In other examples, video stream 116 may be a recorded video file that is being streamed for transmission.

Static element 120 generally represents any group of pixels within a video stream that changes infrequently between frames compared to other elements. For example, a static element may change every five frames, ten frames, or one hundred frames, compared to other elements, which may change every frame or every other frame. In some examples, a static element may not change at all between frames (i.e., may persist unchanged for the entire length of the video). In one example, a static element may be a contiguous group of pixels, such as a rectangle. In other examples, a static element may include multiple non-contiguous groups of pixels, such as two unconnected horizontal bars. In some examples, a static element may include a graphical overlay. A graphical overlay generally represents any type of digital graphic added in post-processing on top of (e.g., visually occluding part of) a video stream. Examples of graphical overlays may include, without limitation, a presenter's name on a talk show known in the industry as a “lower third” graphic, a score display on a sporting event, and/or any other type of persistent graphic added (e.g., composited) on top of a video.

Dynamic element 118 generally represents any pixels within a video stream that change frequently between frames compared to a static element. For example, a dynamic element may change between every frame or almost every frame. In some examples, most of a video stream may be composed of dynamic elements. For example, a graphical overlay showing a baseball score may be a static element while the field, players, and stands may all be dynamic elements because each of these things may change sufficiently to alter the values of most or all of the pixels in a frame during any given camera shot as well as between one shot and another.

Higher-quality video stream 122 generally represents any video stream that is encoded in a way that is somehow higher in quality than a lower-quality video stream 124. For example, a higher-quality video stream may be encoded with a higher resolution than a lower-quality video stream. Additionally or alternatively, a higher-quality video stream may be encoded via a more resource-intensive codec than a lower-quality video stream. In some examples, a higher-quality video stream may be encoded at a higher quality than the original video stream from which the static element was extracted. In some examples, a lower-quality video stream may be encoded at a lower quality than the original video stream while in other examples, the lower-quality video stream may be encoded at the same quality as the original video stream.

As illustrated in FIG. 1, computing device 106 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of the modules illustrated in FIG. 1. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules stored in memory 140. Additionally or alternatively, physical processor 130 may execute one or more of the modules. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

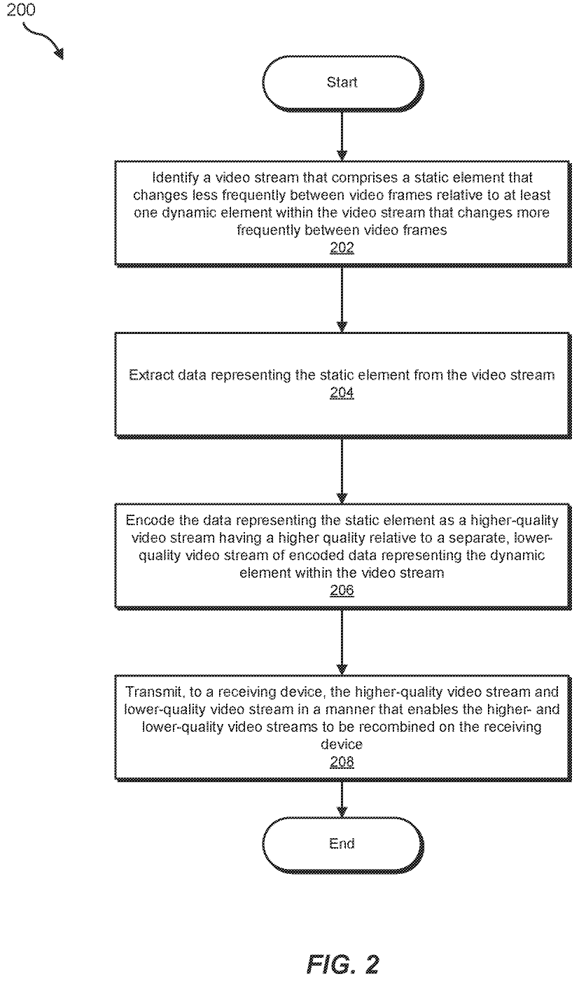

FIG. 2 is a flow diagram of an exemplary method 200 for multi-stream video encoding. In some examples, at step 202, the systems described herein may identify a video stream that includes a static element that changes less frequently between video frames relative to at least one dynamic element within a video stream that changes more frequently between video frames.

The systems described herein may identify the static element and the dynamic element in a variety of ways. In some examples, the systems described herein may match the static element to a stored static element in a static element library. The term static element library may generally refer to any collection of stored graphical elements. In one example, the static element may be a graphical overlay showing the score of a sporting event, the systems described herein may have a library of graphical score overlays used by various networks, and the systems described herein may detect a graphical score overlay from the library in the video stream. In some embodiments, the systems described may train a machine learning model to identify static elements to store in the static element library.

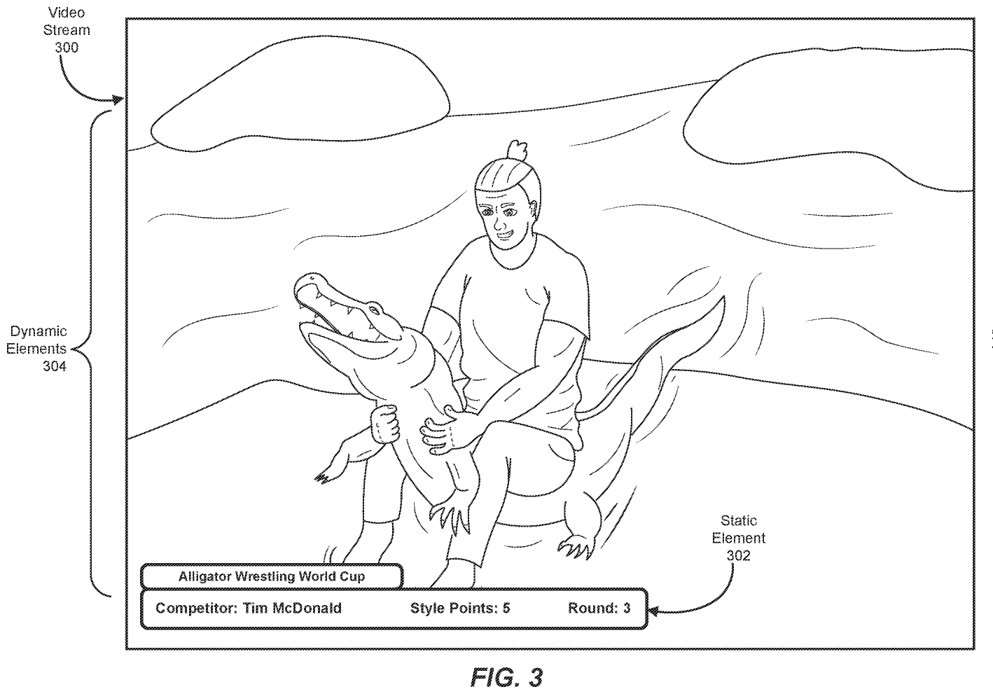

Additionally or alternatively, the systems described herein may monitor the video stream and detect which pixels change less frequently between frames. For example, as illustrated in FIG. 3, a video stream 300 may include dynamic elements 304 such as a river, a grassy slope, an alligator, and an alligator wrestler, that all change frequently between frames. By contrast, a static element 302 such as an overlay that shows the competitor's name and score may not change, even as the alligator moves, the camera pans, or the shot switches to a different camera.

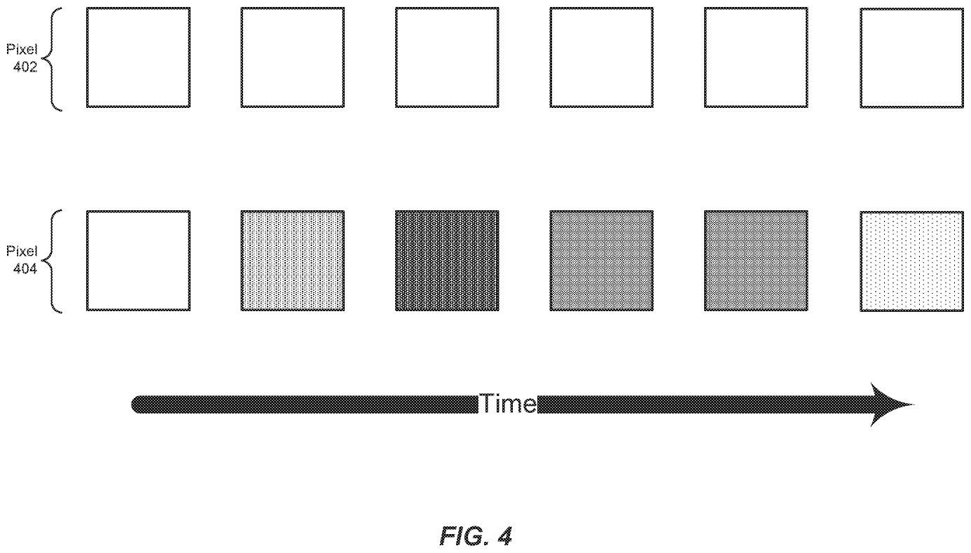

In some examples, the pixels that make up a dynamic element may change between most or all frames, while the pixels that make up a static element may not change for quite a few frames. For example, as illustrated in FIG. 4, a pixel 402 may have the same value from frame to frame over time, while a pixel 404 may change values between almost every frame. In one example, the systems described herein may monitor pixel 402 and pixel 404 and determine, based on the relative rates of change, that pixel 402 is part of a static element while pixel 404 is part of a dynamic element.

Returning to FIG. 2, at step 204, the systems described herein may extract data representing the static element from the video stream. The systems described herein may extract this data in various ways automatically. For example, the systems described herein may extract data describing the values of the pixels that represent the static element from a stream of data that describes the pixels in each frame of the video stream. In one example, as illustrated in FIG. 500, the systems described herein may identify a video stream 500 that includes a static element 502 and may extract static element 502 from video stream 500 to form a stream of static content 506. In some embodiments, the systems described herein may treat any part of video stream 500 that is not static content 506 as dynamic content 504. That is, the systems described herein may not separately algorithmically identify both static and dynamic elements. Rather, in some embodiments, the systems described herein may algorithmically identify static elements and then may classify remaining data from the video stream (i.e., some or all data other than the data representing the static elements) as being the dynamic elements.

Returning to FIG. 2, at step 206, the systems described herein may encode the data representing the static element as a higher-quality video stream having a higher quality relative to a separate, lower-quality video stream of encoded data representing the dynamic element within the video stream.

The systems described herein may encode the higher-quality video stream in a variety of ways. In some embodiments, the systems described herein may encode only the higher-quality video stream, while in other embodiments, the systems described herein may encode both the higher-quality video stream of the data representing the dynamic element and may also encode a lower-quality video stream of encoded data representing the dynamic element that does not include data representing the static element. In some examples, encoding the lower-quality video stream may include encoding data from the video stream other than the data representing the static element. In one example, this may include encoding all data except the data representing the static element. In other embodiments, the systems described herein may encode a higher-quality video stream that includes data representing the static element that can be combined with the original video stream (which includes both the static and dynamic elements) to form a higher-quality video stream than the original video stream, rather than encoding two new streams that do not include overlapping data.

In some embodiments, the systems described herein may encode the data representing the static element at a higher resolution and/or via a more resource-intensive codec than the data representing the dynamic elements. In some examples, because the static element does not frequently change between frames, the systems described herein may encode the static element at a lower framerate with minimal loss of quality. Thus, the systems described herein may efficiently (e.g., in terms of computing resources, file size, and/or time) encode a higher-quality version of the static element than is possible when encoding a stream that also includes dynamic elements which must be encoded at a higher framerate to avoid loss of visual quality. Similarly, the systems described herein may encode the data representing the dynamic elements at a higher framerate but a lower resolution, because the human eye has difficulty detecting the difference between resolutions when elements are rapidly changing. In some examples, by encoding the static and dynamic elements in this way, the total file size (e.g., in megabytes of data stored in memory and/or in megabytes/second of data transferred via a network) of the combined higher-quality and lower-quality streams may be less than the file size of the original video stream, consuming less bandwidth while maintaining or even improving subjective visual quality.

At step 208, the systems described herein may transmit, to a receiving device, the higher-quality video stream and lower-quality video stream in a manner that enables the higher-and lower-quality video streams to be recombined on the receiving device. The systems described herein may transmit the video streams in a variety of ways and/or contexts. For example, the systems described herein may transmit the video streams via one or more wired and/or wireless network connections (e.g., one or more local area networks connected to the Internet). In some embodiments, the systems described herein may transmit the video streams separately, while in other embodiments, the systems described herein may transmit the video streams as a combined message, series of messages, and/or file. In one example, the systems described herein may take advantage of the separation of graphics and video by transmitting the graphics in vector rather than raster format. In some embodiments, the systems described herein may enable users to separately scale graphics up or down (e.g., to enable vision-impaired users to see a scoreboard or name more clearly), disable graphics, and/or receive a different version of graphics (e.g., a text overlay in a different language).

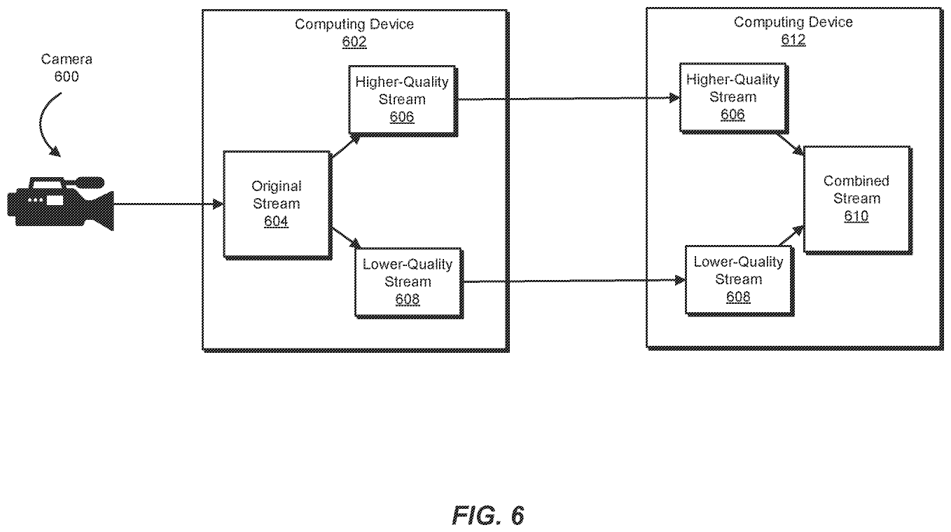

In some embodiments, the systems described herein may receive an original video stream from a recording device, encode separate higher-and lower-quality streams of static and dynamic content respectively, and transmit those streams to a computing device that recombines the streams. For example, as illustrated in FIG. 6, a camera 600 may capture an original stream 604 of video data. Though illustrated as a single camera, camera 600 may represent multiple physical and/or virtual cameras and/or post-processing applications. A computing device 602 may extract data representing any static elements within original stream 604 into a higher-quality stream 606 and encode the remainder of the data into a lower-quality stream 608. Computing device 602 may transmit both streams to a computing device 612 (e.g., an endpoint device) that combines higher-quality stream 606 and lower-quality stream 608 into a combined stream 610 that features high-resolution low-framerate static elements and low-resolution high-framerate dynamic elements.

In some embodiments, the systems described herein may enable computing device 612 to decode higher-quality stream 606 via software decoding while decoding lower-quality stream 608 via hardware decoding or vice versa. In some examples, this may enable computing device 612 to detect and/or manipulate an alpha channel, higher bit-depth color, and/or gradients in the static content in higher-quality stream 606 without expending computing resources performing the same action on the dynamic content in lower-quality stream 608.

In some examples, the systems described herein may detect that the static element is no longer present in the video stream and, in response to detecting that the static element is no longer present in the video stream, encode and transmit a single video stream rather than the higher-quality video stream and the lower-quality video stream. For example, returning to FIG. 3, the systems described herein may detect that the stream of the alligator wrestling competition has cut to a commercial break. During the commercial break, static element 302 that displays the competitor and score will not be present. In response, the systems described herein may cease splitting the stream into higher-and lower-quality streams and may instead encode and transmit the original stream until the commercial break is over and the systems described herein detect that static element 302 (or a different static element) is now present again, at which point the systems described herein may resume splitting the stream into the higher-and lower-quality streams. The systems described herein may detect that the static element is no longer present in a variety of ways, including monitoring the values of the pixels and detecting that the pixels now frequently change and/or detecting metadata indicating a change to a different type of content (e.g., by detecting a cue tone that indicates a cut to or from a commercial).

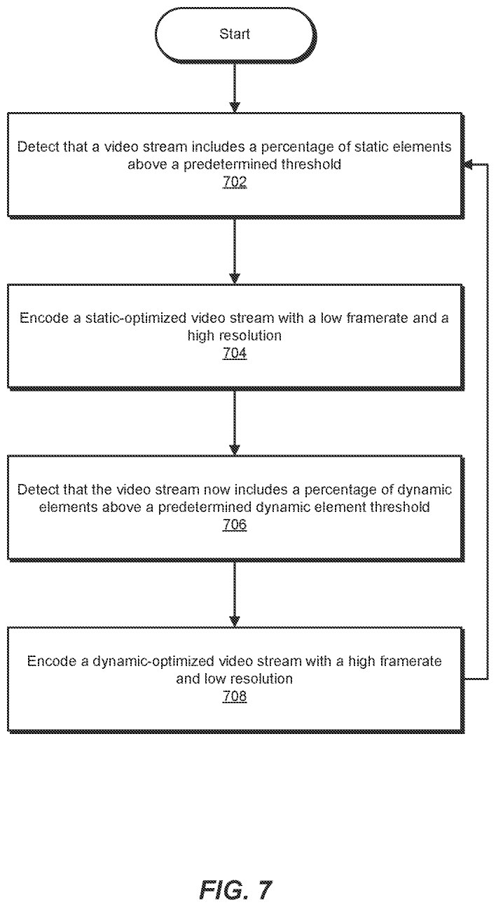

In some embodiments, rather than or in addition to detecting static and dynamic elements within the stream and creating separate streams, the systems described herein may classify an entire stream as primarily static or primarily dynamic content and encode the stream with specific settings based on that classification. For example, as illustrated in FIG. 7, at step 702, the systems described herein may detect that a video stream includes a percentage of static elements above a predetermined threshold. The systems described herein may use various predetermined thresholds, such as 95%, 90%, 80%, or 70%. In response to detecting that the video stream includes a percentage of static elements above the predetermined threshold, at step 704, the systems described herein may encode a static-optimized video stream. The term static-optimized video stream may generally refer to any video stream with a low framerate and/or a high resolution compared to a general-purpose video stream.

At some later point, at step 706, the systems described herein may detect that the video stream now includes a percentage of dynamic elements above a predetermined dynamic element threshold. In some embodiments, the dynamic element threshold may be the inverse of the static element threshold (e.g., the dynamic element threshold may be 30% if the static element threshold is 70%) while in other embodiments, it may be possible for a stream to meet neither threshold (e.g., if both thresholds are greater than 50%), in which case the stream may not be encoded in either a specific way optimized for mostly static content or a specific way optimized for mostly dynamic content. In response to detecting that the video stream now includes a percentage of dynamic elements above the predetermined dynamic element threshold, at step 708, the systems described herein may encode a dynamic-optimized video stream with a high framerate and low resolution. The systems described herein may continue switching between a dynamic-optimized encoding strategy, a static-optimized encoding strategy, and/or a general-purpose encoding strategy in response to detecting changes in the relative static and dynamic content of the stream. By encoding a stream based on the percentage of static or dynamic content, the systems described herein may conserve computing resources (e.g., processing power, bandwidth, etc.) and/or create a stream with higher subjective visual quality for viewers.

As described above, the systems and methods described herein may improve encoding efficiency in terms of computing resources, time, and/or bandwidth without sacrificing visual quality by encoding static elements at a high resolution and low framerate and dynamic elements at a low resolution and high framerate. This encoding strategy takes advantage of the natural characteristics of human vision, where blur is difficult to detect in moving elements but very easy to detect in static elements, as well as the characteristics of a large amount of video content, such as talk shows and sporting events, that include persistent static elements. For example, a static score overlay at 1080p in front of smooth 60 frames-per-second motion at 540p may appear better to the human eye than the same video with both elements at 720p. By splitting out video in this way, the systems described herein may encode each type of element in the most suitable way to produce the highest subjective quality result.

### EXAMPLE EMBODIMENTS

Example 1: A method for multi-stream video encoding may include (i) identifying a video stream that includes a static element that changes less frequently between video frames relative to at least one dynamic element within the video stream that changes more frequently between video frames, (ii) extracting data representing the static element from the video stream, (iii) encoding the data representing the static element as a higher-quality video stream having a higher quality relative to a separate, lower-quality video stream of encoded data representing the dynamic element within the video stream, and (iv) transmitting, to a receiving device, the higher-quality video stream and lower-quality video stream in a manner that enables the higher-and lower-quality video streams to be recombined on the receiving device.

Example 2: The computer-implemented method of example 1, the static element includes a graphical overlay.

Example 3: The computer-implemented method of examples 1-2, where identifying the video stream that includes the static element includes matching the static element to a stored static element in a static element library.

Example 4: The computer-implemented method of examples 1-3, where encoding the data representing the static element as the video stream having the higher quality relative to the separate, lower-quality video stream of the encoded data representing the dynamic element within the video stream includes encoding the lower-quality video stream of encoded data representing the dynamic element.

Example 5: The computer-implemented method of examples 1-4, where encoding the lower-quality video stream of encoded data representing the dynamic element includes encoding data from the video stream other than the data representing the static element.

Example 6: The computer-implemented method of examples 1-5, where encoding the data representing the static element as the video stream having the higher quality relative to the separate, lower-quality video stream of the encoded data representing the dynamic element within the video stream includes encoding the higher-quality video stream at a higher resolution than the lower-quality video stream.

Example 7: The computer-implemented method of examples 1-6, where encoding the data representing the static element as the video stream having the higher quality relative to the separate, lower-quality video stream of the encoded data representing the dynamic element within the video stream includes encoding the higher-quality video stream at a lower framerate than the lower-quality video stream.

Example 8: The computer-implemented method of examples 1-7, where a total file size of the higher-quality video stream combined with the lower-quality video stream is smaller than a file size of the video stream.

Example 9: The computer-implemented method of examples 1-8 may further include detecting that the static element is no longer present in the video stream and, in response to detecting that the static element is no longer present in the video stream, encoding and transmitting a single video stream rather than the higher-quality video stream and the lower-quality video stream.

Example 10: The computer-implemented method of examples 1-9 may further include, in response to detecting that the video stream includes a percentage of static elements above a predetermined threshold, encoding a static-optimized video stream at a higher resolution and lower framerate than the video stream.

Example 11: The computer-implemented method of examples 1-10 may further include detecting that the video stream now includes a percentage of dynamic elements above a predetermined dynamic element threshold and, in response to detecting that the video stream now includes the percentage of dynamic elements above the predetermined dynamic element threshold, encoding a dynamic-optimized video stream at a lower resolution and higher framerate than the static-optimized video stream.

Example 12: A system for multi-stream video encoding may include at least one physical processor and physical memory including computer-executable instructions that, when executed by the physical processor, cause the physical processor to (i) identify a video stream that includes a static element that changes less frequently between video frames relative to at least one dynamic element within the video stream that changes more frequently between video frames, (ii) extract data representing the static element from the video stream, (iii) encode the data representing the static element as a higher-quality video stream having a higher quality relative to a separate, lower-quality video stream of encoded data representing the dynamic element within the video stream, and (iv) transmit, to a receiving device, the higher-quality video stream and lower-quality video stream in a manner that enables the higher-and lower-quality video streams to be recombined on the receiving device.

Example 13: The system of example 12, where the static element includes a graphical overlay.

Example 14: The system of examples 12-13, where identifying the video stream that includes the static element includes matching the static element to a stored static element in a static element library.

Example 15: The system of examples 12-14, where encoding the data representing the static element as the video stream having the higher quality relative to the separate, lower-quality video stream of the encoded data representing the dynamic element within the video stream includes encoding the lower-quality video stream of encoded data representing the dynamic element.

Example 16: The system of examples 12-15, where encoding the lower-quality video stream of encoded data representing the dynamic element includes encoding data from the video stream other than the data representing the static element.

Example 17: The system of examples 12-16, where encoding the data representing the static element as the video stream having the higher quality relative to the separate, lower-quality video stream of the encoded data representing the dynamic element within the video stream includes encoding the higher-quality video stream at a higher resolution than the lower-quality video stream.

Example 18: The system of examples 12-17, where encoding the data representing the static element as the video stream having the higher quality relative to the separate, lower-quality video stream of the encoded data representing the dynamic element within the video stream includes encoding the higher-quality video stream at a lower framerate than the lower-quality video stream.

Example 19: The system of examples 12-18, where a total file size of the higher-quality video stream combined with the lower-quality video stream is smaller than a file size of the video stream.

Example 20: A non-transitory computer-readable medium may include one or more computer-readable instructions that, when executed by at least one processor of a computing device, cause the computing device to (i) identify a video stream that includes a static element that changes less frequently between video frames relative to at least one dynamic element within the video stream that changes more frequently between video frames, (ii) extract data representing the static element from the video stream, (iii) encode the data representing the static element as a higher-quality video stream having a higher quality relative to a separate, lower-quality video stream of encoded data representing the dynamic element within the video stream, and (iv) transmit, to a receiving device, the higher-quality video stream and lower-quality video stream in a manner that enables the higher-and lower-quality video streams to be recombined on the receiving device.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory,

Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive video data to be transformed, transform the video data by splitting one video stream into two video streams, output a result of the transformation to encode each stream at a different quality level and/or with different encoding settings, use the result of the transformation to transmit each video stream to a receive device to be recombined and/or played, and store the result of the transformation to create a saved video file. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
identifying a video stream that comprises a static element that changes less frequently between video frames relative to at least one dynamic element within the video stream that changes more frequently between video frames;
extracting data representing the static element from the video stream;
encoding the data representing the static element as a higher-quality video stream having a higher quality relative to a separate, lower-quality video stream of encoded data representing the dynamic element within the video stream; and
transmitting, to a receiving device, the higher-quality video stream and lower-quality video stream in a manner that enables the higher-and lower-quality video streams to be recombined on the receiving device.

2. The computer-implemented method of claim 1, wherein the static element comprises a graphical overlay.

3. The computer-implemented method of claim 1, wherein identifying the video stream that comprises the static element comprises matching the static element to a stored static element in a static element library.

4. The computer-implemented method of claim 1, wherein encoding the data representing the static element as the video stream having the higher quality relative to the separate, lower-quality video stream of the encoded data representing the dynamic element within the video stream comprises encoding the lower-quality video stream of encoded data representing the dynamic element.

5. The computer-implemented method of claim 4, wherein encoding the lower-quality video stream of encoded data representing the dynamic element comprises encoding data from the video stream other than the data representing the static element.

6. The computer-implemented method of claim 1, wherein encoding the data representing the static element as the video stream having the higher quality relative to the separate, lower-quality video stream of the encoded data representing the dynamic element within the video stream comprises encoding the higher-quality video stream at a higher resolution than the lower-quality video stream.

7. The computer-implemented method of claim 1, wherein encoding the data representing the static element as the video stream having the higher quality relative to the separate, lower-quality video stream of the encoded data representing the dynamic element within the video stream comprises encoding the higher-quality video stream at a lower framerate than the lower-quality video stream.

8. The computer-implemented method of claim 1, wherein a total file size of the higher-quality video stream combined with the lower-quality video stream is smaller than a file size of the video stream.

9. The computer-implemented method of claim 1, further comprising:
detecting that the static element is no longer present in the video stream; and
in response to detecting that the static element is no longer present in the video stream, encoding and transmitting a single video stream rather than the higher-quality video stream and the lower-quality video stream.

10. The computer-implemented method of claim 1, further comprising, in response to detecting that the video stream comprises a percentage of static elements above a predetermined threshold, encoding a static-optimized video stream at a higher resolution and lower framerate than the video stream.

11. The computer-implemented method of claim 10, further comprising:
detecting that the video stream now comprises a percentage of dynamic elements above a predetermined dynamic element threshold; and
in response to detecting that the video stream now comprises the percentage of dynamic elements above the predetermined dynamic element threshold, encoding a dynamic-optimized video stream at a lower resolution and higher framerate than the static-optimized video stream.

12. A system comprising:
at least one physical processor; and
physical memory comprising computer-executable instructions that, when executed by the physical processor, cause the physical processor to:
identify a video stream that comprises a static element that changes less frequently between video frames relative to at least one dynamic element within the video stream that changes more frequently between video frames;
extract data representing the static element from the video stream;
encode the data representing the static element as a higher-quality video stream having a higher quality relative to a separate, lower-quality video stream of encoded data representing the dynamic element within the video stream; and
transmit, to a receiving device, the higher-quality video stream and lower-quality video stream in a manner that enables the higher-and lower-quality video streams to be recombined on the receiving device.

13. The system of claim 12, wherein the static element comprises a graphical overlay.

14. The system of claim 12, wherein identifying the video stream that comprises the static element comprises matching the static element to a stored static element in a static element library.

15. The system of claim 12, wherein encoding the data representing the static element as the video stream having the higher quality relative to the separate, lower-quality video stream of the encoded data representing the dynamic element within the video stream comprises encoding the lower-quality video stream of encoded data representing the dynamic element.

16. The system of claim 15, wherein encoding the lower-quality video stream of encoded data representing the dynamic element comprises encoding data from the video stream other than the data representing the static element.

17. The system of claim 12, wherein encoding the data representing the static element as the video stream having the higher quality relative to the separate, lower-quality video stream of the encoded data representing the dynamic element within the video stream comprises encoding the higher-quality video stream at a higher resolution than the lower-quality video stream.

18. The system of claim 12, wherein encoding the data representing the static element as the video stream having the higher quality relative to the separate, lower-quality video stream of the encoded data representing the dynamic element within the video stream comprises encoding the higher-quality video stream at a lower framerate than the lower-quality video stream.

19. The system of claim 12, wherein a total file size of the higher-quality video stream combined with the lower-quality video stream is smaller than a file size of the video stream.

20. A non-transitory computer-readable medium comprising one or more computer-readable instructions that, when executed by at least one processor of a computing device, cause the computing device to:
identify a video stream that comprises a static element that changes less frequently between video frames relative to at least one dynamic element within the video stream that changes more frequently between video frames;
extract data representing the static element from the video stream;
encode the data representing the static element as a higher-quality video stream having a higher quality relative to a separate, lower-quality video stream of encoded data representing the dynamic element within the video stream; and
transmit, to a receiving device, the higher-quality video stream and lower-quality video stream in a manner that enables the higher-and lower-quality video streams to be recombined on the receiving device.
